(19) United States
(12) Patent Application Publication
(10) Pub. No.: US 2010/0023905 A1
(43) Pub. Date: Jan. 28, 2010

(54) Critical Area Deterministic Sampling

(76) Inventors: Fedor G. Pikus, Beaverton, OR (US); John W. Stedman, Beaverton, OR (US)

Correspondence Address: MENTOR GRAPHICS CORP.;PATENT GROUP, 8005 SW BOECKMAN ROAD, WILSONVILLE, OR, 97070-7777, US

(21) Appl. No.: 12/390,354

(22) Filed: Feb. 20, 2009

Related U.S. Application Data
(60) Provisional application No. 61/030,204, filed on Feb. 20, 2008.

(51) Int. Cl. G06F 17/50

(52) U.S. Cl. 716/7; 716/10; 716/11

(57) ABSTRACT

A layout design for a portion of a microdevice design is partitioned into sections or “bins.” Next, a critical area value is estimated for one or more of the bins. One or more of these estimated bins is then selected for a more detailed analysis. After the estimated bins have been selected, a detailed critical area analysis of the selected bins is performed. Once the actual critical area for each of the estimated bins has been determined, the actual critical areas for selected estimated bins are correlated with those bin's corresponding estimated values. By correlating the actual critical areas of selected estimated bin to those bin's corresponding estimated values, a mapping function can be determined. After the mapping function has been determined, it is applied to the estimated values for each of the remaining bins of the layout design (i.e., the bins for which an actual critical area have not yet been determined) to obtain critical area information for the layout design. The layout design can then be modified based upon the obtained critical area information.

### RELATED APPLICATIONS

This application claims priority under 35 U.S.C. §119 to U.S. Provisional Patent Application No. 61/030,204, filed on Feb. 20, 2008, entitled “Critical Area Deterministic Sampling” and naming Fedor G. Pikus and John W. Stedman as inventors, which application is incorporated entirely herein by reference.

### FIELD OF THE INVENTION

The present invention is directed to the determination of characteristics of microdevice design data based upon sampling selected portions of the design. Various aspects of the invention may be particularly beneficial for performing a relatively fast analysis of the critical area in a microdevice design.

### BACKGROUND OF THE INVENTION

Electronic circuits, such as integrated microcircuits, are used in a variety of products, from automobiles to microwaves to personal computers. Designing and fabricating microcircuit devices typically involves many steps, known as a “design flow.” The particular steps of a design flow often are dependent upon the type of microcircuit, its complexity, the design team, and the microcircuit fabricator or foundry that will manufacture the microcircuit. Typically, software and hardware “tools” verify the design at various stages of the design flow by running software simulators and/or hardware emulators, and errors in the design are corrected or the design is otherwise improved.

Several steps are common to most design flows. Initially, the specification for a new circuit is transformed into a logical design, sometimes referred to as a register transfer level (RTL) description of the circuit. With this logical design, the circuit is described in terms of both the exchange of signals between hardware registers and the logical operations that are performed on those signals. The logical design typically employs a Hardware Design Language (HDL), such as the Very high speed integrated circuit Hardware Design Language (VHDL). The logic of the circuit is then analyzed, to confirm that it will accurately perform the functions desired for the circuit. This analysis is sometimes referred to as “functional verification.”

After the accuracy of the logical design is confirmed, it is converted into a device design by synthesis software. The device design, which is typically in the form of a schematic or netlist, describes the specific electronic devices (such as transistors, resistors, and capacitors) that will be used in the circuit, along with their interconnections. This device design generally corresponds to the level of representation displayed in conventional circuit diagrams. Preliminary timing estimates for portions of the circuit may be made at this stage, using an assumed characteristic speed for each device. In addition, the relationships between the electronic devices are analyzed, to confirm that the circuit described by the device design will correctly perform the desired functions. This analysis is sometimes referred to as “formal verification.”

Once the relationships between circuit devices have been established, the design is again transformed, this time into a physical design that describes specific geometric elements. This type of design often is referred to as a “layout” design. The geometric elements, which typically are polygons, define the shapes that will be created in various materials to manufacture the circuit. Typically, a designer will select groups of geometric elements representing circuit device components (e.g., contacts, gates, etc.) and place them in a design area. These groups of geometric elements may be custom designed, selected from a library of previously-created designs, or some combination of both. Lines are then routed between the geometric elements, which will form the wiring used to interconnect the electronic devices. Layout tools (often referred to as “place and route” tools), such as Mentor Graphics' IC Station or Cadence's Virtuoso, are commonly used for both of these tasks.

With a layout design, each physical layer of the circuit will have a corresponding layer representation in the design, and the geometric elements described in a layer representation will define the relative locations of the circuit device components that will make up a circuit device. Thus, the geometric elements in the representation of an implant layer will define the regions where doping will occur, while the geometric elements in the representation of a metal layer will define the locations in a metal layer where conductive wires will be formed to connect the circuit devices. Typically, a designer will perform a number of analyses on the layout design. For example, the layout design may be analyzed to confirm that it accurately represents the circuit devices and their relationships as described in the device design. The layout design also may be analyzed to confirm that it complies with various design requirements, such as minimum spacings between geometric elements. Still further, the layout design may be modified to include the use of redundant geometric elements or the addition of corrective features to various geometric elements, to counteract limitations in the manufacturing process, etc.

In particular, the design flow process may include one or more resolution enhancement technique (RET) processes. These processes will modify the layout design data, to improve the usable resolution of the reticle or mask created from the design in a photolithographic manufacturing process. One such family of resolution enhancement technique (RET) processes, sometimes referred to as optical proximity correction (OPC) processes, may add features such as serifs or indentations to existing layout design data in order to compensate for diffractive effects during a lithographic manufacturing process. For example, an optical proximity correction process may modify a polygon in a layout design to include a “hammerhead” shape, in order to decrease rounding of the photolithographic image at the corners of the polygon.

After the layout design has been finalized, it is converted into a format that can be employed by a mask or reticle writing tool to create a mask or reticle for use in a photolithographic manufacturing process. Masks and reticles typically are made using tools that expose a blank reticle or mask substrate to an electron or laser beam (or to an array of electron beams or laser beams). Most mask writing tools are able to only “write” certain kinds of polygons, however, such as right triangles, rectangles or other trapezoids. Moreover, the sizes of the polygons are limited physically by the maximum beam (or beam array) size available to the tool. Accordingly, larger geometric elements in the layout design, or geometric elements that are not right triangles, rectangles or trapezoids (which typically are a majority of the geometric elements in a layout design) must be “fractured” into the smaller, more basic polygons that can be written by the mask or reticle writing tool. This process sometimes is referred to as “mask data preparation.”

Once a layout design has been fractured into shots, then the fractured layout design data can be converted to a format compatible with the mask or reticle writing tool. Examples of such formats are MEBES, for raster scanning machines manufactured by ETEC, an Applied Materials Company, and various vector scan formats for Nuflare, JEOL, and Hitachi machines, such as VSB11 or VSB12. The written masks or reticles then can be used in a photolithographic process to expose selected areas of a wafer to light or other radiation in order to produce the desired integrated circuit devices on the wafer.

### SUMMARY OF THE INVENTION

With various examples of the invention, a layout design data is partitioned into sections or “bins.” Next, a critical area value is estimated for one or more of the bins. One or more of these “estimated” bins (that is, bins for which a critical area value has been estimated) is then selected for a more detailed analysis. After the estimated bins have been selected, a detailed critical area analysis of the selected bins is performed. Once the actual critical area for each of the estimated bins has been determined, the actual critical areas for selected estimated bins are correlated with those bin's corresponding estimated values.

The estimated critical area value for a bin will have some relation to the actual critical area of the bin. Typically, this relationship can be expressed as a mapping function. By correlating the actual critical areas of selected estimated bin to those bin's corresponding estimated values, the mapping function can be determined. After the mapping function has accurately been determined, it can be applied to the estimated values for each of the remaining bins of the layout design (i.e., the bins for which an actual critical area have not yet been determined). The layout design can then be modified based upon the determined critical area information.

### BRIEF DESCRIPTION OF THE DRAWINGS

FIG. 1 illustrates a computing system that may be used to implement various embodiments of the invention.

FIG. 2 illustrates an example of a multi-core processor unit that may be used to implement various embodiments of the invention.

FIG. 3 illustrates the effect of particles on the manufacture of structures during a lithographic process.

FIG. 4 illustrates a critical area determination tool that may be implemented according to various embodiments of the invention.

### DETAILED DESCRIPTION OF THE INVENTION

### Operating Environment

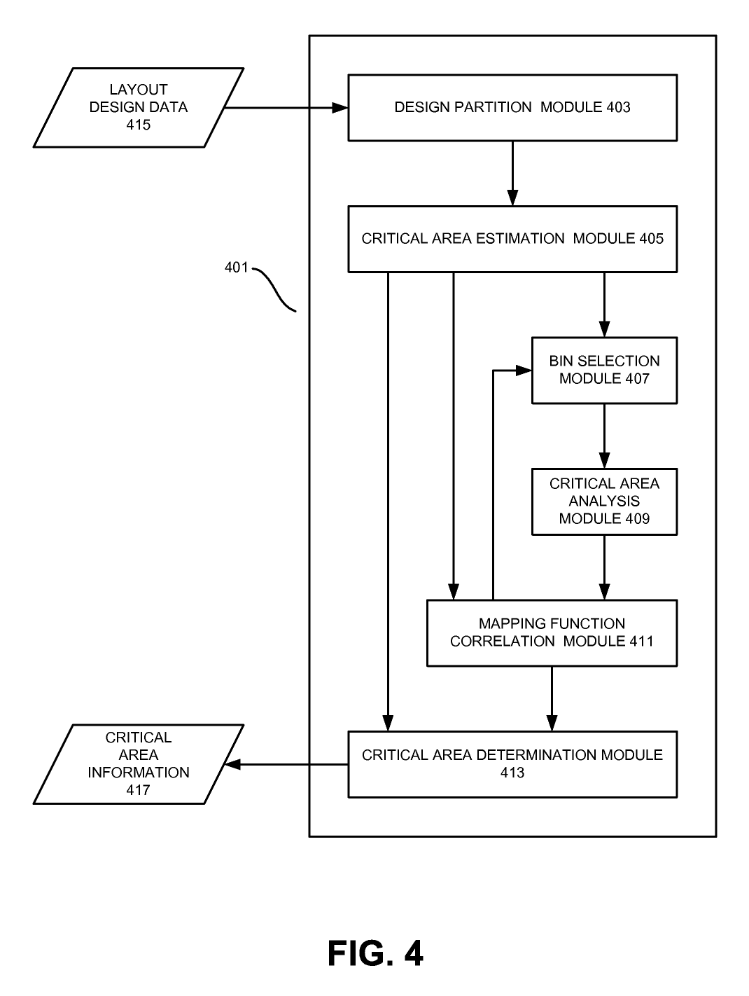

The execution of various electronic design automation processes according to embodiments of the invention may be implemented using computer-executable software instructions executed by one or more programmable computing devices. Because these embodiments of the invention may be implemented using software instructions, the components and operation of a generic programmable computer system on which various embodiments of the invention may be employed will first be described. Further, because of the complexity of some electronic design automation processes and the large size of many circuit designs, various electronic design automation tools are configured to operate on a computing system capable of simultaneously running multiple processing threads. The components and operation of a computer network having a host or master computer and one or more remote or servant computers therefore will be described with reference to FIG. 4. This operating environment is only one example of a suitable operating environment, however, and is not intended to suggest any limitation as to the scope of use or functionality of the invention.

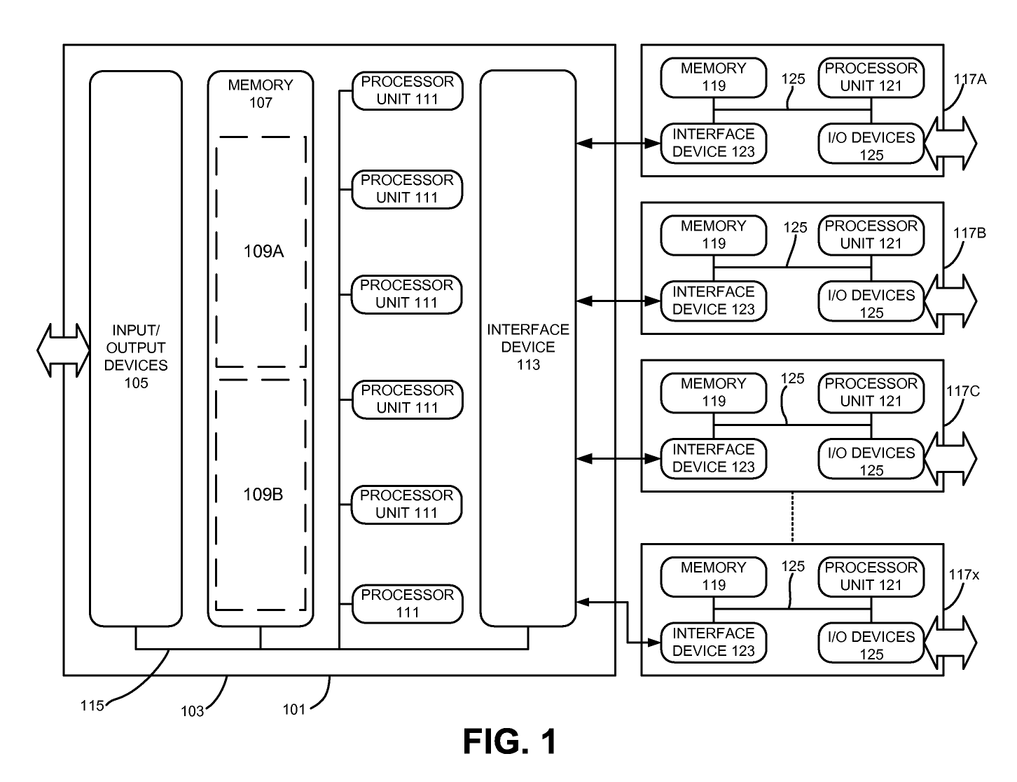

In FIG. 1, the computer network 101 includes a master computer 103. In the illustrated example, the master computer 103 is a multi-processor computer that includes a plurality of input and output devices 105 and a memory 107. The input and output devices 105 may include any device for receiving input data from or providing output data to a user. The input devices may include, for example, a keyboard, microphone, scanner or pointing device for receiving input from a user. The output devices may then include a display monitor, speaker, printer or tactile feedback device. These devices and their connections are well known in the art, and thus will not be discussed at length here.

The memory 107 may similarly be implemented using any combination of computer readable media that can be accessed by the master computer 103. The computer readable media may include, for example, microcircuit memory devices such as read-write memory (RAM), read-only memory (ROM), electronically erasable and programmable read-only memory (EEPROM) or flash memory microcircuit devices, CD-ROM disks, digital video disks (DVD), or other optical storage devices. The computer readable media may also include magnetic cassettes, magnetic tapes, magnetic disks or other magnetic storage devices, punched media, holographic storage devices, or any other medium that can be used to store desired information.

As will be discussed in detail below, the master computer 103 runs a software application for performing one or more operations according to various examples of the invention. Accordingly, the memory 107 stores software instructions 109A that, when executed, will implement a software application for performing one or more operations. The memory 107 also stores data 109B to be used with the software application. In the illustrated embodiment, the data 109B contains process data that the software application uses to perform the operations, at least some of which may be parallel.

The master computer 103 also includes a plurality of processor units 111 and an interface device 113. The processor units 111 may be any type of processor device that can be programmed to execute the software instructions 109A, but will conventionally be a microprocessor device. For example, one or more of the processor units 111 may be a commercially generic programmable microprocessor, such as Intel® Pentium® or Xeon™ microprocessors, Advanced Micro Devices Athlon™ microprocessors or Motorola 68K/Coldfire® microprocessors. Alternately or additionally, one or more of the processor units 111 may be a custom-manufactured processor, such as a microprocessor designed to optimally perform specific types of mathematical operations. The interface device 113, the processor units 111, the memory 107 and the input/output devices 105 are connected together by a bus 115.

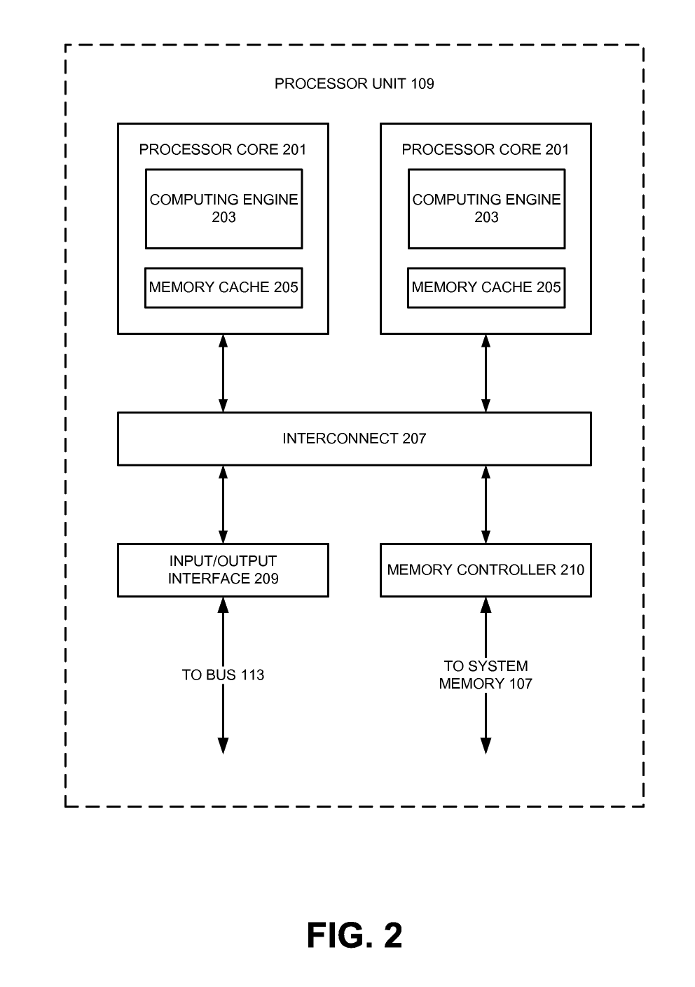

With some implementations of the invention, the master computing device 103 may employ one or more processing units 111 having more than one processor core. Accordingly, FIG. 2 illustrates an example of a multi-core processor unit 111 that may be employed with various embodiments of the invention. As seen in this figure, the processor unit 111 includes a plurality of processor cores 201. Each processor core 201 includes a computing engine 203 and a memory cache 205. As known to those of ordinary skill in the art, a computing engine contains logic devices for performing various computing functions, such as fetching software instructions and then performing the actions specified in the fetched instructions. These actions may include, for example, adding, subtracting, multiplying, and comparing numbers, performing logical operations such as AND, OR, NOR and XOR, and retrieving data. Each computing engine 203 may then use its corresponding memory cache 205 to quickly store and retrieve data and/or instructions for execution.

Each processor core 201 is connected to an interconnect 207. The particular construction of the interconnect 207 may vary depending upon the architecture of the processor unit 201. With some processor cores 201, such as the Cell microprocessor created by Sony Corporation, Toshiba Corporation and IBM Corporation, the interconnect 207 may be implemented as an interconnect bus. With other processor units 201, however, such as the Opteron™ and Athlon™ dual-core processors available from Advanced Micro Devices of Sunnyvale, Calif., the interconnect 207 may be implemented as a system request interface device. In any case, the processor cores 201 communicate through the interconnect 207 with an input/output interface 209 and a memory controller 211. The input/output interface 209 provides a communication interface between the processor unit 201 and the bus 115. Similarly, the memory controller 211 controls the exchange of information between the processor unit 201 and the system memory 107. With some implementations of the invention, the processor units 201 may include additional components, such as a high-level cache memory accessible shared by the processor cores 201.

While FIG. 2 shows one illustration of a processor unit 201 that may be employed by some embodiments of the invention, it should be appreciated that this illustration is representative only, and is not intended to be limiting. For example, some embodiments of the invention may employ a master computer 103 with one or more Cell processors. The Cell processor employs multiple input/output interfaces 209 and multiple memory controllers 211. Also, the Cell processor has nine different processor cores 201 of different types. More particularly, it has six or more synergistic processor elements (SPEs) and a power processor element (PPE). Each synergistic processor element has a vector-type computing engine 203 with 428×428 bit registers, four single-precision floating point computational units, four integer computational units, and a 556 KB local store memory that stores both instructions and data. The power processor element then controls that tasks performed by the synergistic processor elements. Because of its configuration, the Cell processor can perform some mathematical operations, such as the calculation of fast Fourier transforms (FFTs), at substantially higher speeds than many conventional processors.

It also should be appreciated that, with some implementations, a multi-core processor unit 111 can be used in lieu of multiple, separate processor units 111. For example, rather than employing six separate processor units 111, an alternate implementation of the invention may employ a single processor unit 111 having six cores, two multi-core processor units each having three cores, a multi-core processor unit 111 with four cores together with two separate single-core processor units 111, etc.

Returning now to FIG. 1, the interface device 113 allows the master computer 103 to communicate with the servant computers 117A, 117B, 117C . . . 117x through a communication interface. The communication interface may be any suitable type of interface including, for example, a conventional wired network connection or an optically transmissive wired network connection. The communication interface may also be a wireless connection, such as a wireless optical connection, a radio frequency connection, an infrared connection, or even an acoustic connection. The interface device 113 translates data and control signals from the master computer 103 and each of the servant computers 117 into network messages according to one or more communication protocols, such as the transmission control protocol (TCP), the user datagram protocol (UDP), and the Internet protocol (IP). These and other conventional communication protocols are well known in the art, and thus will not be discussed here in more detail.

Each servant computer 117 may include a memory 119, a processor unit 121, an interface device 123, and, optionally, one more input/output devices 125 connected together by a system bus 127. As with the master computer 103, the optional input/output devices 125 for the servant computers 117 may include any conventional input or output devices, such as keyboards, pointing devices, microphones, display monitors, speakers, and printers. Similarly, the processor units 121 may be any type of conventional or custom-manufactured programmable processor device. For example, one or more of the processor units 121 may be commercially generic programmable microprocessors, such as Intel® Pentium® or Xeon™ microprocessors, Advanced Micro Devices Athlon™ microprocessors or Motorola 68K/Coldfire® microprocessors. Alternately, one or more of the processor units 121 may be custom-manufactured processors, such as microprocessors designed to optimally perform specific types of mathematical operations. Still further, one or more of the processor units 121 may have more than one core, as described with reference to FIG. 2 above. For example, with some implementations of the invention, one or more of the processor units 121 may be a Cell processor. The memory 119 then may be implemented using any combination of the computer readable media discussed above. Like the interface device 113, the interface devices 123 allow the servant computers 117 to communicate with the master computer 103 over the communication interface.

In the illustrated example, the master computer 103 is a multi-processor unit computer with multiple processor units 111, while each servant computer 117 has a single processor unit 121. It should be noted, however, that alternate implementations of the invention may employ a master computer having single processor unit 111. Further, one or more of the servant computers 117 may have multiple processor units 121, depending upon their intended use, as previously discussed. Also, while only a single interface device 113 or 123 is illustrated for both the master computer 103 and the servant computers, it should be noted that, with alternate embodiments of the invention, either the computer 103, one or more of the servant computers 117, or some combination of both may use two or more different interface devices 113 or 123 for communicating over multiple communication interfaces.

With various examples of the invention, the master computer 103 may be connected to one or more external data storage devices. These external data storage devices may be implemented using any combination of computer readable media that can be accessed by the master computer 103. The computer readable media may include, for example, microcircuit memory devices such as read-write memory (RAM), read-only memory (ROM), electronically erasable and programmable read-only memory (EEPROM) or flash memory microcircuit devices, CD-ROM disks, digital video disks (DVD), or other optical storage devices. The computer readable media may also include magnetic cassettes, magnetic tapes, magnetic disks or other magnetic storage devices, punched media, holographic storage devices, or any other medium that can be used to store desired information. According to some implementations of the invention, one or more of the servant computers 117 may alternately or additionally be connected to one or more external data storage devices. Typically, these external data storage devices will include data storage devices that also are connected to the master computer 103, but they also may be different from any data storage devices accessible by the master computer 103.

It also should be appreciated that the description of the computer network illustrated in FIG. 1 and FIG. 2 is provided as an example only, and it not intended to suggest any limitation as to the scope of use or functionality of alternate embodiments of the invention.

### Critical Area Analysis

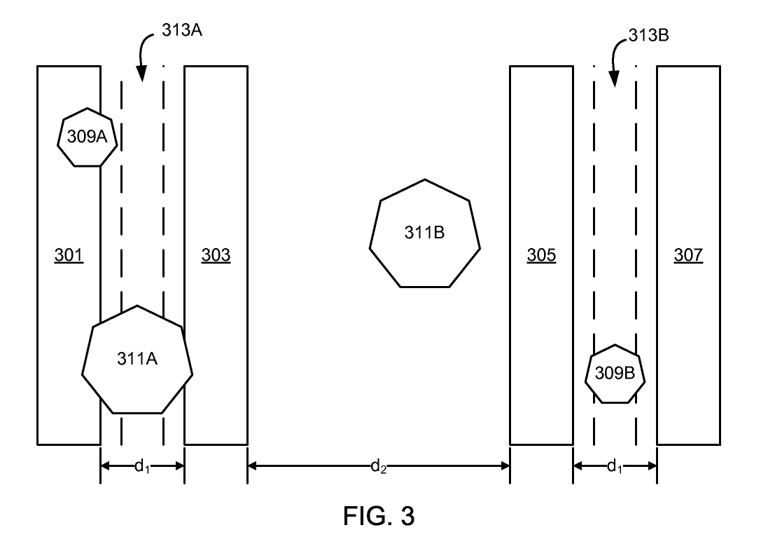

Various embodiments of the invention may be employed to determine the critical area of microdevice layout design data. As known in the art, the critical area of a microdevice design can be used to analyze how environmental factors may cause random defects in a microdevice during a manufacturing process. An illustration of a design's susceptibility to particle induced defects is shown in FIG. 3. More particularly, FIG. 3 illustrates four parallel connection lines 301-307. The connection line 301 is spaced at a distance d1 from the connection line 303. Similarly, the connection line 305 is spaced at a distance d1 from the connection line 307. Connection lines 303 and 305 are then separated by a distance d2 that is greater than the distance d1. As will be appreciated by those of ordinary skill in the art, particles in the atmosphere during the manufacturing process can damage or even destroy the functionality of adjacent connection lines. For example, a particle contacting two adjacent connection lines may bridge the lines, causing them to work improperly. For this reason, manufacturers strictly control the number and size of particles in their microcircuit fabrication rooms.

The likelihood of this type of bridging fault occurring in a pair of adjacent connection lines depends upon the number of particles, the size of the particles, and the distance between the adjacent connection lines. As shown in FIG. 3, particles 309 have a smaller width than the distance d1, and thus cannot create a bridge between any of the connection lines 301-307. Larger particles 311, however, are wider than distance d1. Accordingly, because the width of a particle 311 is smaller than distance d2, a particle 311 will not create a bridge between connection lines 303 and 305. If, however, a particle 311 falls within an area 313 between connection lines 301 and 303 or between 305 and 307, then the particle 311 will bridge the adjacent connection lines. Similarly, a small particle 309 may be too small to prevent a connection line (e.g., connection line 301) from forming. A larger particle, however, such as the particle 311, might be wider than the width of a connection line. Accordingly, the presence of such a particle could cause a connection line to be formed with a gap in it (sometimes referred to as an “open” fault).

To determine the risk to a layout design to these particle-caused faults, a designer or manufacturer may perform a critical area analysis. That is, the designer or manufacturer may determine the total amount of area in the design that is susceptible to open faults from particles of a particular size or size range. Similarly, the designer or manufacturer may determine the total amount of area in the design that is susceptible to bridging faults from particles of a particular size or size range. The designer or manufacturer may perform these critical area analyses for a variety of different particle sizes (or ranges of particle sizes). Such analyses, however, can be time-consuming and computationally intensive.

### Critical Area Determination Tool

FIG. 4 illustrates an example of a critical area determination tool 401 that may be implemented according to various examples of the invention. As seen in this figure, the critical area determination tool 401 includes a design partition module 403, a critical area estimation module 405, a bin selection module 407, a critical area analysis module 409, a mapping function correlation module 411, and a critical area determination module 413. As previously noted, each of these modules may be implemented by a computer executing instructions, or by computer-executable instructions stored on a computer-readable medium. Also, while each of the modules 403-413 are shown and discussed separately, the functionality of any of the modules 403-413 can be combined with other modules as desired.

Initially, the design partition module 403 obtains layout design data 415, and partitions the layout design data 415 into sections or “bins.” Next, the critical area estimation module 405 estimates a critical area value for each of the bins. With various examples of the invention, the critical area estimation module 405 will analyze a bin to determine some value related to the actual critical area for that bin. For example, with some implementations of the invention, the critical area estimation module 405 may measure the width of the spacing between each pair of geometric elements in the design that are less than a specified particle size (or range of sizes). The critical area estimation module 405 may then, for example, multiply that width by the length for which the geometric elements run parallel to estimate the critical area for bridging faults. Alternately, the critical area estimation module 405 may measure the width of each geometric element that are narrower than a specified particle size (or range of sizes). The critical area estimation module 405 may then, for example, multiply each width by the length of the geometric element to estimate the critical area for open faults. It should be appreciated that, with various examples of the invention, the technique used by the critical area estimation module 405 to estimate the critical area for a bin typically will be faster than performing an actual critical area calculation for that bin. After the critical area estimation module 405 has determined a critical area estimate value for each bin, it orders the bins according to the magnitude of those values.

Next, the bin selection module 407 selects one or more of the bins for a more detailed analysis. The bin selection module 407 may select a bin for a detailed analysis using any desired technique. For example, the bin selection module 407 may divide the ordering of the bins into quadrants, and then select the bin with the median estimate value for each quadrant. Further, the bin selection module 407 may additionally select the bins offset from the median bins by some desired amount. With various examples of the invention, the selection of bins may depend upon the number of available processors (or processing cores) available to the tool 401. For example, if 100 processors are available to the tool 401, then the bin selection module 407 may divide the ordering of the bins up into 100 equal sets, and select the bin with the median estimated value from each set.

After the bins have been selected, the critical area analysis module 409 performs a detailed critical area analysis of the selected bins. The critical area analysis module 409 may use any desired conventional analysis technique to calculate the actual critical area for each selected bin. Once the actual critical area for each bin has been determined, the mapping function correlation module 411 correlates the actual critical area for each selected bin to that bin's estimated value.

As previously noted, the estimated value for a bin will have some relation to the actual critical area of the bin. Typically, this relationship can be expressed as a mapping function. By correlating the actual critical area of each selected bin to that bin's estimated value, the mapping function correlation module 411 can determine the mapping function. If the correlation does not converge sufficiently for the mapping function correlation module 411 to accurately determine the mapping function, then the bin selection module 407 will select additional bins for a detailed analysis. Again, the bin selection module 407 can employ any desired methodology to select additional bins for the detailed analysis. The critical area analysis module 409 will determine the actual critical area for each of these newly selected bins, and the mapping function correlation module 411 will correlate the actual critical areas for these newly selected bins against the estimated values for those bins, to improve the accuracy of the mapping function. This process can be repeated until the mapping function converges to a desired degree.

After the mapping function correlation module 411 has accurately determined the mapping function for the estimated values, it applies the mapping function to the estimated values for each of the remaining bins of the layout design (i.e., the bins for which an actual critical area have not yet been determined). By using the mapping function, the critical area determination module 413 can provide relatively accurate critical area information 417 for these remaining bins, and thus for the layout design data 415 as a whole.

### CONCLUSION

While specification embodiments of the invention have been shown and described in detail above to illustrate the principles of the invention, it will be understood that the invention may be otherwise embodied without departing from the invention. Thus, while the invention has been described with respect to specific examples including presently preferred modes of carrying out the invention, those of ordinary skill in the art will appreciate that there are numerous variations and permutations of the above described systems and techniques that fall within the spirit and scope of the invention

What is claimed is:

1. A method of determining a critical area of a layout design for a portion of a microdevice, comprising:
partitioning the layout design into bins;
estimating a critical area value for one or more of the bins;
performing a detailed critical area analysis for the estimated bins to determine an actual critical area value for each of the selected bins;
correlating the actual critical areas of estimated bins with their corresponding estimated values to determine a mapping function;
applying the mapping function to the estimated values of bins for which an actual critical area value has not been determined, to obtain critical area information for the layout design.

2. A method for modifying a layout design for a portion of a microdevice design, comprising:
partitioning the layout design into bins;
estimating a critical area value for one or more of the bins;
performing a detailed critical area analysis for the estimated bins to determine an actual critical area value for each of the selected bins;
correlating the actual critical areas of estimated bins with their corresponding estimated values to determine a mapping function;
applying the mapping function to the estimated values of bins for which an actual critical area value has not been determined, to obtain critical area information for the layout design; and
modifying the layout design based upon the determined critical area information.

3. A apparatus for determining a critical area of a layout design for a portion of a microdevice, comprising:
a design partition module that partitions a layout design into bins;
a critical area estimation module that estimates a critical area value for one or more of the bins;
a critical area analysis module that performs a detailed critical area analysis for the estimated bins to determine an actual critical area value for each of the selected bins;
a mapping function correlation module that correlates the actual critical areas of estimated bins with their corresponding estimated values to determine a mapping function; and
a critical area determination module that applies the mapping function to the estimated values of bins for which an actual critical area value has not been determined, to obtain critical area information for the layout design.
